(19) United States
(12) Patent Application Publication
(10) Pub. No.: US 2008/0259551 A1
(43) Pub. Date: Oct. 23, 2008

(54) MODULAR COMPUTING DEVICE

(75) Inventors: Ivan Gavenda, Vrutky (SK); Viliam Sameliak, Namestovo (SK)

Correspondence Address: FISH & RICHARDSON P.C., P.O. BOX 1022, MINNEAPOLIS, MN, 55440-1022, US

(73) Assignee: GOTIVE A.S., Bratislava (SK)

(21) Appl. No.: 11/738,230

(22) Filed: Apr. 20, 2007

(51) Int. Cl. G06F 1/16

(52) U.S. Cl. 361/684; 361/686; 361/728

(57) ABSTRACT

A core computing device including a body housing a processor, the body defining a plurality of couplings for receiving a plurality of modules along a plurality of sides thereof, the body defining tabs extending from corners of a periphery of the body for mechanically interfacing with the modules. The functionality of the device can be dynamically configured and extended by attaching various modules, where particular combinations of modules may also be paired to achieve particular results.

### FIELD

The present disclosure generally relates to a modular computing device.

### BACKGROUND

Conventional portable devices, such as laptop computers, personal digital assistants (PDAs) or mobile telephones, often suffer from limited functionality and inextensibility. For example, conventional handheld devices often includes a small number of ports, to which a limited variety of peripheral devices may be connected.

### SUMMARY

In one general aspect, a modular computing device kit includes a core having a body housing a processor, the body defining a plurality of couplings for receiving a plurality of modules along a plurality of sides thereof, and at least one module configured for removable receipt by the coupling, the module, when received by the core, conforming to a perimeter of the core to define a form factor of the modular computing device.

Implementations may include one or more of the following features. For example, modular computing device kit may further include a plurality of interchangeable modules, or the body may further house a memory, an input interface, and a display. The display may have a width:height ratio of 16:9. The at least one module may include a global system for mobile communication (GSM) module, a general packet radio service (GPRS) module, an enhanced data GSM environment (EDGE) module, a wireless network interface module, a BLUETOOTH® module, a near field communications (NFC) module; an infrared (IR) transmitter, and IR receiver, a speaker, a keyboard, a user input module, a port replicator, a battery, a bar code reader, a radio frequency identification (RFID) tag reader, a smart card reader, a compact flash card reader, a magnetic stripe reader, a fingerprint reader, a global positioning satellite (GPS) receiver, a printer, an imager or scanner, a camera, a security access module (SAM), or a subscriber interface module (SIM).

The coupling may be a universal serial bus (USB) connection coupling, an inter-integrated circuit (I²C) connection coupling, a serial connection coupling, a parallel connection coupling, a Personal Computer Memory Card International Association (PCMCIA) card slot coupling, a Peripheral Component Interconnect (PCI) connection coupling, a small computer system interface (SCSI) connection coupling, or a PS/2 connection. When the at least one module is received by the core, the form factor of the modular computer device may be rectangular, square-shaped, round-shaped, polygonal, or has a combination of one or more straight sides and one or more curved sides, and a watertight or airtight seal may be created between the at least one module and the core. The body may include at least four sides.

According to another general implementation a core computing device includes a body housing a processor, the body defining a plurality of couplings for receiving a plurality of modules along a plurality of sides thereof, the body defining tabs extending from corners of a periphery of the body for mechanically interfacing with the modules.

According to another general implementation a module includes a body housing electronics, the body defining a groove for receipt of a side of a core computing device and having a coupling positioned on the body within the groove for electrically contacting the core computing device, the body including pins extending from first and second ends of the body for mechanically interfacing with tabs extending from corners of a periphery of the core computing device. The pins may be spring-loaded pins.

According to another general implementation, a frame for interfacing a core computing device and a plurality of modules includes a body defining a cavity for receiving the core computing device, the body including a coupling positioned on the body within the cavity for electrically contacting the core computing device, the body defining a plurality of couplings for receiving a plurality of modules along a plurality of sides thereof, the body defining tabs extending from corners of a periphery of the body for mechanically interfacing with the modules.

According to another general implementation, an adapter for interfacing a core computing device and a plurality of modules includes a body configured for receiving the core computing device and a plurality of the modules.

According to another general implementation, a method of reconfiguring a computing device includes exchanging modules attached to a core of the computing device to change the functionality of the computing device, the modules, when attached to the core, conforming to a perimeter of the core to define a form factor of the computing device.

According to another general implementation a docking station includes a body housing electronics, the body defining a groove for receipt of a side of a core computing device and having a coupling positioned on the body within the groove for electrically contacting the core computing device, the body including pins extending from first and second ends of the body for mechanically interfacing with tabs extending from corners of a periphery of the core computing device, and the electronics enabling a wireline connection of peripheral devices.

The details of one or more implementations are set forth in the accompanying drawings and the description below. Other features and advantages of the disclosure will be apparent from the description and drawings, and from the claims.

### BRIEF DESCRIPTION OF THE DRAWINGS

FIGS. 1 and 2 are perspective views of an exemplary modular computing device, in a state where four modules are attached to and detached from a frame of the modular computing device, respectively.

FIGS. 3 and 4 are a frontal view and a rear view of the exemplary modular computing device illustrated in FIG. 1, respectively.

FIG. 5 is an expanded, side cut-away view of the exemplary modular computing device illustrated in FIG. 1, viewed along line A-A′ of FIG. 3.

FIG. 6 is a block diagram illustrating an exemplary internal architecture of the core processing unit.

FIGS. 7 to 10 illustrate exemplary connectors used to connect corresponding components of the modular computing device.

FIGS. 11 to 17 illustrate various exemplary modules connected to the frame.

FIGS. 18 to 20 are perspective views of exemplary multi-sided modular computing devices, according to other general implementations.

FIGS. 21 and 22 are perspective views of an exemplary frame and detachable core processing unit, in an attached and detached state, respectively.

FIGS. 23 and 24 are perspective views of an exemplary frame, detachable core processing unit, and adapter, in an attached and detached state, respectively.

FIG. 25 is a perspective view of an exemplary modular computing device, in a state where four modules and a detachable core processing unit are detached from a frame of the modular computing device.

### DETAILED DESCRIPTION

Referring to FIGS. 1 to 5, a substantially rectangular modular computing device kit 100 includes modules 101 and 102 which are respectively disposed on first and second opposite sides of a frame 106 of a modular computing device kit 100, and modules 103 and 104 which are respectively disposed on third and fourth opposite sides of the frame 106 of the modular computing device. The first and second sides are approximately perpendicular to the third and fourth sides, where the first though fourth sides define the perimeter of the frame 106 of the modular computing device kit 100. As viewed by a user of the modular computing device kit 100, the modules 101 to 104 may be alternatively described as the left, right, top and bottom modules, respectively. In alternate implementations, the modular computing device kit 100 is square-shaped, round-shaped, polygonal, or has a combination of one or more straight sides and one or more curved sides.

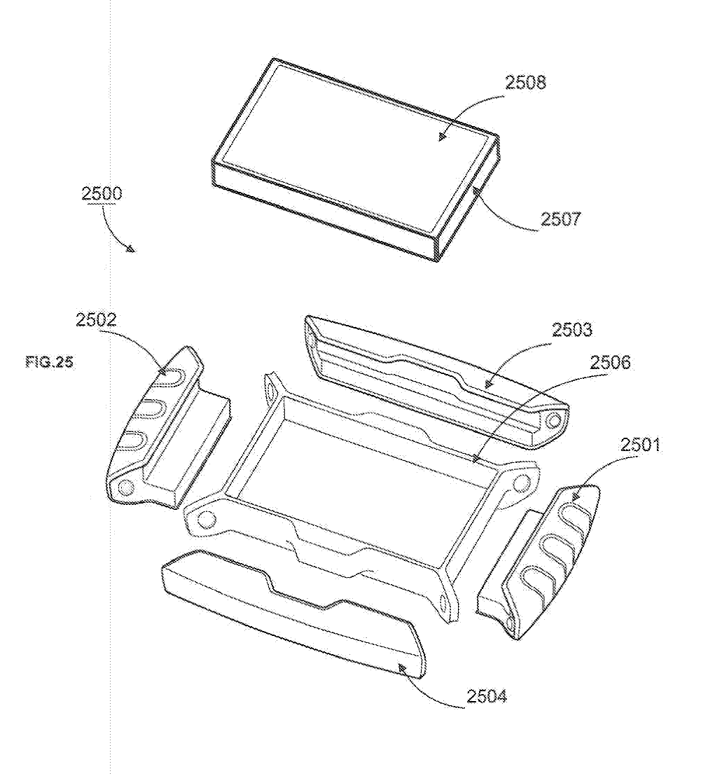

The modules 101 to 104 are electrically connected to a frame 106 and a core processing unit 107 by way of module-side connectors, such as connectors 109 and 110, and frame-side connectors, such as connectors 111 and 112, where the module-side connectors are configured to connect to frame-side connectors. The core processing unit 107 includes a display 108. Although the connectors effectuate a wireline electrical connection between the modules 101 to 104, the frame 106, and the core processing unit 107, in an alternate implementation an interface is provided between at least some of these components using a wireless connection, and one or more of the connectors merely provide a mechanical coupling. In a further alternate implementation (see FIG. 25), the one or more of the connectors are omitted, and a mechanical coupling between the modules 101 to 104 and the frame 106 is provided by the frame 106 itself.

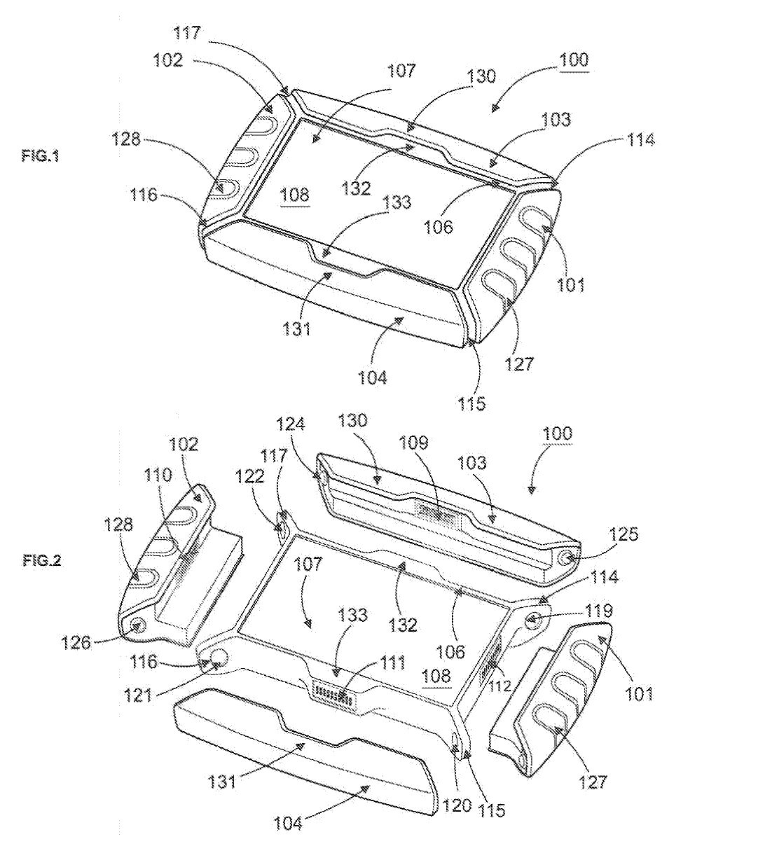

In the implementation illustrated in FIGS. 1 and 2, the modular computing device kit 100 includes four corner projections (or ‘tabs’) 114 to 117 extending away from the core processing unit 107 of the modular computing device kit 100 at each corner of the frame 106. Each corner projection includes a through-hole, such as through-holes 119 to 122, which mechanically couple with pins extending from ends of the modules, such as pins 124 to 126, thereby supporting the modules and allowing a user to easily and intuitively connect the modules to the frame 106. The pins may be static pins, which grasp the through-holes by way of a snap fit or a friction fit, or they may be spring loaded to more firmly couple the modules to the frame. When connected to the modular computing device kit 100, the four modules 101 to 104 conform to the perimeter of the core processing unit 107.

The frame 106 provides at least one point of attachment and support for each of the modules 101 to 104, which thereby become electrically connected to the core processing unit 107. The frame 106 conforms to the perimeter of the core processing unit 107. The frame 106 includes electrical and/or mechanical connection features that engage corresponding features of the modules 101 to 104, interconnecting and securing the modules 101 to 104 to the core processing unit 107. For example, and as described in more detail below with respect to FIGS. 7 to 9, the frame 106 may include tabs that fit into slots of the modules 101 to 104, to releasably hold the modules 101 to 104 to the frame 106, as shown in FIGS. 7 to 9. Although the modules are described as being disposed around a perimeter of a core processing unit the modules may also be connected to other sides, such as a front or rear surface of the frame. When coupled, the module-side connectors and the frame-side connectors may provide mechanical connection to firmly support and releasably hold the modules onto the frame 106, or coupled connectors may merely provide ancillary or no mechanical support to the modules.

In one example implementation, the frame 106 creates a watertight and/or airtight seal with the modules 101 to 104. This seal prevents liquids, moisture, dust, or other substances from reaching the ports and connectors used by the modules 101 to 104 to effectuate an electrical connection with the core processing unit 107. Exemplary ports and connectors used by the modules 101 to 104 are illustrated and described in more detail below, with reference to FIGS. 7 to 9.

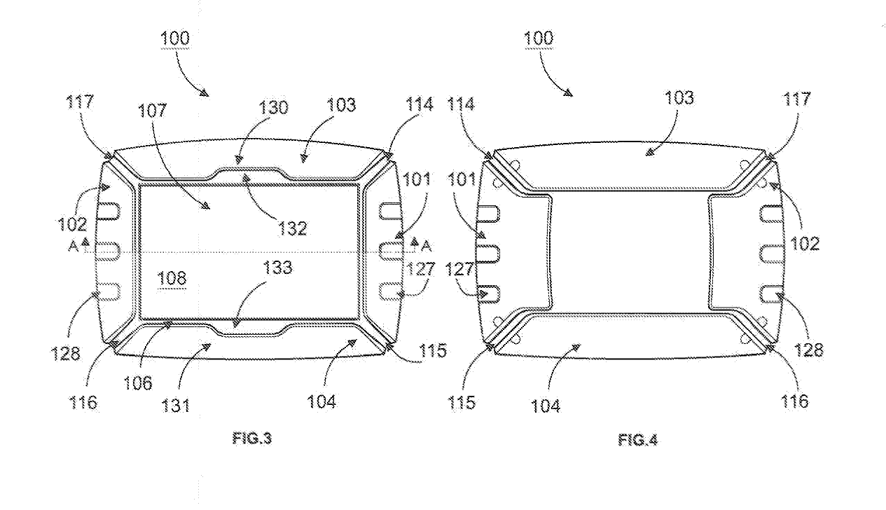

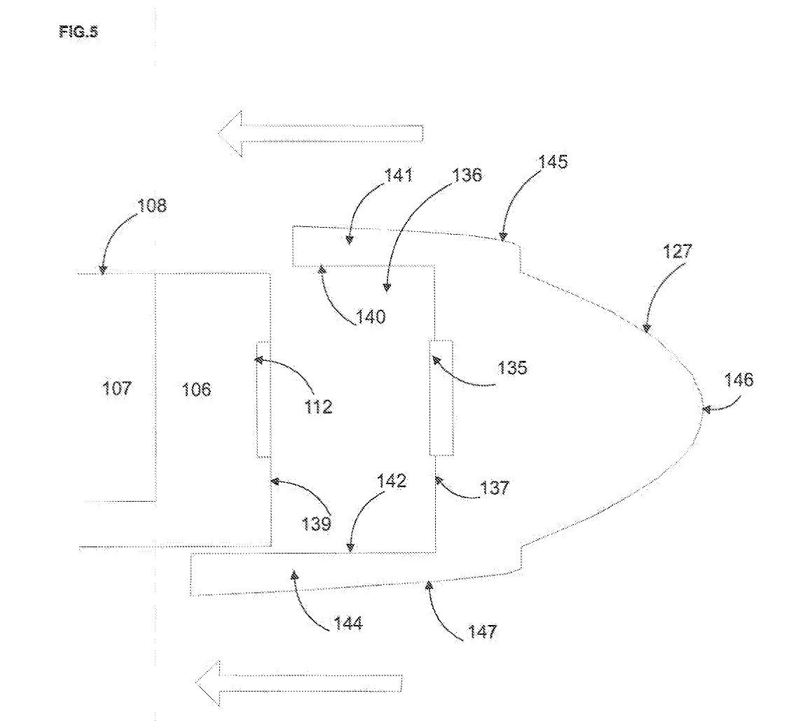

Referring particularly to FIG. 5, which is an expanded, side cut-away view of the exemplary modular computing device kit 100 taken along line A-A′ of FIG. 3, the module 101 includes a module-side connector 135 disposed inside groove 136 on an inner face 137 of the module 101. The inner face 137 is disposed facing an outer face 139 of frame 106, upon which frame-side connector 112 is affixed. In addition to inner face 137, the inside groove 136 also includes front tab inner face 140 disposed on a front tab 141 of the module 101, and rear tab inner face 142 disposed on a rear tab 144 of the module 101. Although the front tab inner face 140 and the rear tab inner face 142 are illustrated as being parallel, in other implementations they may not be.

The front tab 141 is disposed upon a surface of the module 101 nearest to the display 108, and the rear tab 142 is disposed upon a surface of the module opposite to the display 108. Either tab may be used to protect, hide, or otherwise cover visible portions of the frame 106, to provide an extra grip for the user to grasp the modular computing device kit 100, or may be used to effectuate a friction fit between the module 101 and the frame 106. In the illustrated example implementation, the front tab 141 is shorter than the rear tab 144, although in alternate implementations the tabs may be substantially equal-sized, or the front tab 141 may be longer than the rear tab 144. The module 101 also includes a front surface 145, an outer surface 146 disposed away from the frame 106, and a rear surface 147.

The modules 101 and 102 each include grip elements, such as grip elements 127 and 128, which better allow a user to handle, orient and otherwise manipulate the modular computing device kit 100 and its corresponding components. Although the grip elements 127 and 128 are shown as U-shaped grip elements, other shapes may be used. The modules 103 and 104 include recessed regions 130 and 131, respectively, which correspond to projections 132 and 133 on the frame 106. The projections 132 and 133 are used, for example, to provide space on the frame 106 for components which effectuate the mechanical and electrical connection between the modules 101 to 104 and the frame 106. In another example implementation, the projections 132 and 133 are merely decorative.

In addition, attached modules provide the modular computing device kit 100 with a particular design, such as a rugged or sleek design. For example, the outer surfaces of the modules 101 to 104 and the grip elements are styled using a rubberized material to provide for a rugged design, or with brushed aluminum to provide for a sleek design. In this regard, the appearance of the modular computing device kit 100 is also changed by selecting or reconfiguring the modules 101 to 104.

The functionality of the modular computing device kit 100 can be dynamically configured and extended by attaching various modules, where particular combinations of modules may also be paired to achieve particular results. In addition to configuring and extending the functionality of the modular computing device kit 100, the modules 101 to 104 also define a form factor and an appearance of the modular computing device kit 100. The modules 101 to 104 may be added to and removed from the modular computing device kit 100 during the operation of the core processing unit 107, to dynamically modify the functionality and the appearance of the modular computing device kit 100. From the perspective of the user, the modules 101 to 104 alter the ergonomics, form factor, and appearance of the modular computing device kit 100. In particular, when attached to the frame 106, the modules 101 to 101 form a coherent, monolithic device.

When mechanically and/or electrically connected to the frame 106, the modules 101 to 104, either alone or in combination with other modules, extend the functionality of the core processing unit 107. For example, in various implementations the modules 101 to 104 may include a global system for mobile communication (“GSM”) module, a general packet radio service (“GPRS”) module, or an enhanced data GSM environment (“EDGE”) module for providing wireless data and voice communication using an internal tri-band, quad band or suitable multi-band antenna and a status light-emitting diode (“LED”); a wireless network interface module such as the INSTITUTE OF ELECTRICAL AND ELECTRONICS ENGINEERS® (“IEEE®”) 802.11a, 802.11b, 802.11g wireless fidelity (“Wi-Fi”) or 802.16 Worldwide Interoperability for Microwave Access 9“WiMAX”) standards module; a BLUETOOTH® module; a near field communications module; an infrared (“IR”) transceiver module; a speaker module for providing mono or stereo audio output; a keyboard module; a user input module; a port replicator module for enabling direct wireline connection of external peripheral devices via an audio port, a direct current (“DC”) power supply port, a universal serial bus (“USB”) port, a 9-pin (DB9) RS-232 port, or another port; a battery module including a removable battery pack and an integrated battery charger circuit and charging status LED; a bar code reader module for performing laser-based reading of one-dimensional symbologies; a radio frequency identification (“RFID”) tag reader module including an internal antenna; a smart card reader module; a compact flash card reader module; a magnetic stripe reader module such as a credit card reader; a fingerprint reader module; a global positioning satellite (“GPS”) receiver module for providing position identification and navigation using an internal antenna and a status LED; a printer module; an imager module for capturing images by performing image-based reading of one or dimensional stacked matrix codes; a scanner module; a camera module for capturing black-and-white or color images; a security access module (“SAM”); or a subscriber interface module (“SIM”). Furthermore, the modules 101 to 104 may be multi-function modules or programmable modules, such that a particular function is performed when selected or otherwise indicated by the user.

In one example implementation, the modules 101 and 102 are each battery modules, while the modules 103 and 104 are both RFID tag reader modules which jointly or individually implement RFID tag reading. Another example implementation, one or more of the modules 101 to 104 are non-functioning, ruggedized modules merely intended to protect the modular computing device kit 100 from damage, by forming a shell around the core processing unit 107.

The frame 106 includes integrally-formed ports and connectors, such as connector 111, via which the modules 101 to 104 are connected to the core processing unit 107. In one example implementation, the connector 111 is electrically connected into a port of the core processing unit 107, and a connector of the modules, such as connector 109 of module 103, is inserted into the connector 111.

The frame 106 also includes other connectors which enable electrical charging of the modular computing device kit 100 and constituent components, and is thus referred to as a docking station for the core processing unit 107. In addition to affecting functionality, the modules 101 to 104 also define the form factor and the appearance of the modular computing device kit 100. When attached to the frame 106, the modules 101 to 104 surround the perimeter of the core processing unit 107, such that most or all of the sides of the modular computing device kit 100 are covered by the visible surfaces of the modules 101 to 104.

The modules 101 to 104 may be removed, added, or rearranged during the operation of the modular computing device kit 100. When such an action occurs, the functionality of the modular computing device kit 100 is quickly and easily changed. For example, a bar code reader module could be quickly and easily replaced with an RFID reader module while the core processing unit is operating. This change would be useful in a retail or warehouse environment, where some objects are identified with bar codes, while others are identified with RFID tags. Under these circumstances, the user can swap the bar code reader with the RFID reader, and vice versa, depending on the objects to be scanned.

According to one general implementation, the frame 106 and the core processing unit 107 form a core. In this implementation, the modular computing device kit 100 includes a core and at least one module configured for removable receipt by a coupling. The core has a body housing a processor, the body defining a plurality of couplings for receiving a plurality of modules along a plurality of sides thereof. The at least one module, when received by the core, conforms to a perimeter of the core to define a form factor of the modular computing device.

According to another general implementation, the frame 106 and the core processing unit 107 form a core computing device. In this implementation, the core computing device includes a body housing a processor, the body defining a plurality of couplings (such as couplings 111 and 112) for receiving a plurality of modules (such as modules 101 to 104) along a plurality of sides thereof. The body defines tabs (such as tabs 114 to 117) extending from corners of the periphery of the body for mechanically interfacing with the modules.

A module, such as modules 101 to 104, includes a body housing electronics, the body defining a groove for receipt of a side of the core computing device and having a coupling (such as coupling 109 and 110 positioned on the body within the groove for electrically connecting the core computing device. As described in further detail below with regard to FIG. 7, the body includes pins extending from first and second ends of the body for mechanically interfacing with tabs extending from corners of a periphery of the core computing device.

According to an additional implementation, reconfiguring a computing includes exchanging modules attached to a core of the computing device to change the functionality of the computing device, the modules, when attached to the core, conforming to a perimeter of the core to define a form factor of the computing device.

The core processing unit 107 is a handheld computer system to which the modules 101 to 104 are electrically connected. The hardware environment of the core processing unit 107 includes the display 108 for displaying text and images to a user, a fixed disk drive, a computer network connection, and a digital input device such as a touch screen sensor for pointing, selecting and manipulating displayed objects displayed on the display 108.

The display 108 displays the graphics, images, and text that comprise the user interface for the software applications used by the core processing unit 107, as well as the operating system programs necessary to operate the core processing unit 107. A user uses a digital input device to enter commands and data to operate and control the computer operating system programs as well as the application programs, and to select and manipulate graphics and text objects displayed on the display 108 as part of the interaction with and control of the core processing unit 107 and applications running on the core processing unit 107. Software is stored locally on computer readable memory media, such as the fixed disk drive.

The display 108 effectuates the presentation of information to a user of the modular computing device kit 100. When the display 108 is a touch screen, the user contacts the display 108 with a stylus, a finger tip, or another object to interact with the modular computing device kit 100. A graphical user interface (GUI) is presented to the user via the display 108, and the user interacts with the GUI by touching the display 108.

The display 108 has a width:height ratio of 4:3, 16:9 or another ratio, and may implement a wide video graphics array (WVGA) display. In one example implementation, the display 108 is approximately 15.24 cm (6 inches) long by 5.08 cm (2 inches) wide, or the display may have a diagonal screen size of 9.65 cm (3.8 inches) to 10.16 cm (4 inches). In other examples, different sized or ratios may also be used.

In a further implementation, the fixed disk drive itself may include a number of physical drive units, such as a redundant array of independent disks (“RAID”), or may be a disk drive farm or a disk array that is physically located in a separate computing unit. Such computer readable memory media allow the core processing unit 107 to access computer-executable process steps, application programs and the like, stored on removable and non-removable memory media.

The computer network connection may be a modern connection, a local-area network (“LAN”) connection including the Ethernet, or a broadband wide-area network (“WAN”) connection such as a digital subscriber line (“DSL”), cable high-speed internet connection, dial-up connection, T-1 line, T-3 line, fiber optic connection, or satellite connection. The network may be a LAN network, a corporate or government WAN network, the Internet, or other network. The computer network connection may be a wireline or wireless connector. Example wireless connectors include, for example, an INFRARED DATA ASSOCIATION® (“IrDA®”) wireless connector, an optical wireless connector, a IEEE® Standard 802.11 wireless connector, a BLUETOOTH® wireless connector, an NFC connector, an orthogonal frequency division multiplexing (“OFDM”) ultra wide band (“UWB”) wireless connector, a time-modulated ultra wide band (“TM-UWB”) wireless connector, or other wireless connector. Example wireline connectors include, for example, a IEEE®-1394 FIREWIRE® connector, a Universal Serial Bus (“USB”) connector, a serial port connector, a parallel port connector, or other wireline connector.

Operating system programs, applications, and various data files, are stored on disks, which are stored on the fixed disk drive. Although the modular computing device kit 100 is illustrated in FIGS. 1 to 5 as handheld computer, in further implementations it may be a desktop personal computer (“PC”), a laptop, a workstation, a midrange computer, a mainframe, an embedded system, telephone, a tablet computer, a PDA, or other type of device.

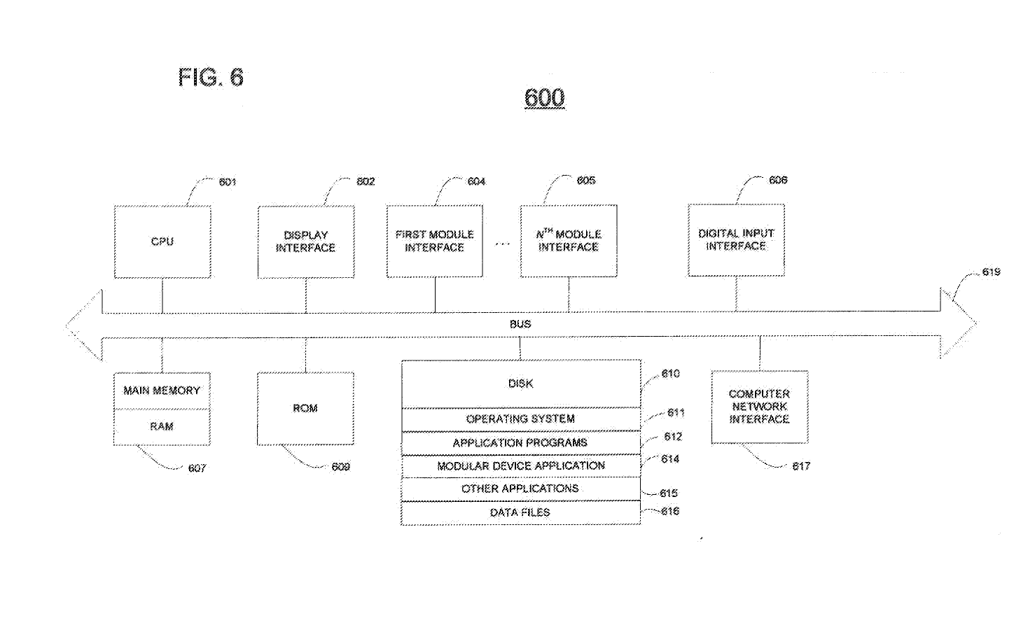

FIG. 6 depicts an example of an internal architecture 600 of the core processing unit 107. The computing environment includes a computer central processing unit (“CPU”) 601 where the computer instructions that comprise an operating system or an application are processed; a display interface 602 which provides a communication interface and processing functions for rendering graphics, images, and texts on the display 108; a first module interface 604 which provides a communication interface to at least a first module, such as module 101; up to an Nth module interface 605 which provides a communication interface to an Nth module interface, as necessary; a digital input interface 606 which provides a communication interface to the digital input device; a random access memory (“RAM”) 607 where computer instructions and data are stored in a volatile memory device for processing by the computer CPU 601; a read-only memory (“ROM”) 609 where invariant low-level systems code or data for basic system functions such as basic input and output (“I/O”), startup, or reception of keystrokes are stored in a non-volatile memory device; a storage 610 or other suitable type of memory (e.g. such as random-access memory (“RAM”), read-only memory (“ROM”), programmable read-only memory (“Prom”), erasable programmable read-only memory (“EPROM”), electrically erasable programmable read-only memory (“EEPROM”), magnetic disks, optical disks, floppy disks, hard disks, removable cartridges, flash drives), where the files that comprise an operating system 611, application programs 612 (including modular computing device application and other applications 615 as necessary) and data files 616 are stored; and a computer network interface 617 which provides a communication interface to the network over the computer network connection. The constituent devices and the computer CPU 601 communicate with each other over the computer bus 619. The module interfaces 604 and 605 can effectuate wireline or wireless communication to their constituent modules, and may be, for example, an NFC interface.

The RAM 607 interfaces with the computer bus 619 so as to provide quick RAM storage to the computer CPU 601 during the execution of software programs such as the operating system application programs, and device drivers. More specifically, the computer CPU 601 loads computer-executable process steps from the fixed disk drive or other memory media into a field of the RAM 607 in order to execute software programs. Data is stored in the RAM 607, where the data is accessed by the computer CPU 601 during execution.

The computer CPU 601 is one of a number of high-performance computer processors, including an INTEL®, AMD® SAMSUNG®, SONY®, TEXAS INSTRUMENTS® processor, a POWERPC® processor, a MIPS® reduced instruction set computer (“RISC”) processor, a SPARC® processor, an ACORN® RISC Machine (“ARM®”) architecture processor, a HP ALPHASERVER® processor or a proprietary computer processor for a mainframe. Example processors may include, for example, an INTEL® XSCALE® or STRONGARM® processor, a SAMSUNG® S3C-class processor, a TEXAS INSTRUMENTS® TI OMAP® processor, a SONY CXD®-class processor or others). In an additional arrangement, the computer CPU 601 is more than one processing unit, including a multiple CPU configuration found in high-performance workstations and servers, or a multiple scalable processing unit found in mainframes.

The operating system 611 may be MICROSOFT® WINDOWS VISTA®/WINDOWS NT®/WINDOWS® 2000/WINDOWS® XP Workstation; WINDOWS NT®/WINDOWS® 2000/WINDOWS® XP Server; a variety of UNIX®-flavored operating systems, including AIX® for IBM® workstations and servers, SUNOS® for SUN® workstations and servers, LINUX® for INTEL® CPU-based workstations and servers, HP UX WORKLOAD MANAGER® for HP® workstations and servers, IRIX® for SGI® workstations and servers, VAX/VMS for Digital Equipment Corporation computers, OPENVMS® for HP ALPHASERVER®-based computers, MAC OS® X for POWERPC® based workstations and servers; SYMBIAN OS®, WINDOWS MOBILE® or WINDOWS CE®, PALM®, NOKIA® OS (“NOS”), OSE®, or EPOC® for mobile devices, or a proprietary operating system for computers or embedded systems. The application development platform or framework for the operating system 221 may be: BINARY RUNTIME ENVIRONMENT FOR WIRELESS® (“BREW®”); Java Platform, Micro Edition (“Java ME”) or Java 2 Platform, Micro Edition (“J2ME®”); PYTHON™, FLASH LITE®, or MICROSOFT® .NET Compact. While FIG. 6 illustrates one possible implementation of an internal architecture for the core processing unit 107, other architectures may also be used as well.

Using a handshaking protocol, the modules 101 to 104 are registered with the core processing unit 107, via at least the first module interface 604. Using handshaking, the modules 101 to 104 provide the module interfaces with a module identifier, and the module interfaces pass the module identifier to the CPU 601 using the bus 619. The core processing unit 107 uses the module identifier to identify the particular functionalities provided by the attached module.

Other registration and authentication procedures may be used by the module interfaces to associate a module with the core processing unit 107, which may ignore those modules which have not been successfully authenticated. For example, the core processing unit may merely power and communicate with authenticated modules. Alternatively, the core processing unit 107 may recognize and communicate with those modules that were made by the manufacturer of the core processing unit 107, thereby preventing unauthorized modules from being used with the core processing unit 107.

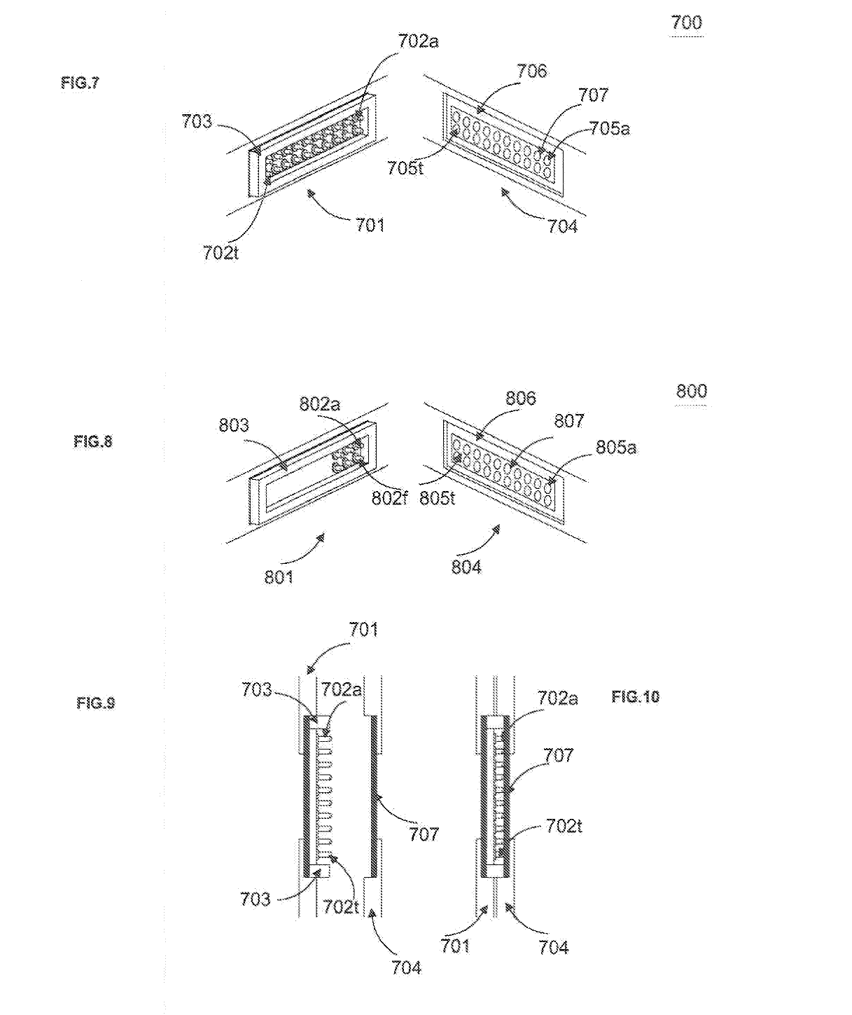

FIGS. 7 to 9 illustrate exemplary connectors, such as those used to connect the frame 106 to the modules 101 to 104. In particular, FIG. 7 is a perspective view of a disconnected connector pair 700, including male connector 701 on a module which includes 20 exposed terminals 702a to 702t and projecting rectangular tab conductive gasket 703, and a receptacle connector 704 on the frame which includes 20 core contact terminals 705a to 705t, a recessed rectangular slot 706, and interface pad 707. FIG. 8 is a perspective view of a disconnected connector pair 800, including a male connector 801 on the frame which includes 6 exposed terminals 802a to 802f and a projecting rectangular tab conductive gasket 803, and a receptacle connector 804 on a module which includes 20 core contact terminals 805a to 805t, a recessed rectangular slot 806, and interface pad 807. As shown in FIGS. 7 and 8, while the number of exposed terminals varies, the number of core contact terminals does not.

The modules 101 to 104 are electrically connected to the core processing unit 107 using connectors, such as connectors 700 and 800, USB connectors, serial connectors, parallel connectors, an inter-integrated circuit (I²C) bus connectors, power connectors, and/or other connectors which pass electrical signals. An electrical connection is formed by fitting a connector on the frame 106 with a connector on the modules 101 to 104 or the core processing unit 107.

A small number of contacts may be sufficient to enable a module to communicate with and the core processing unit 107, for example, because of a relatively small amount of data to be passed between the module and the core processing unit 107. By enabling the use of a varying numbers of contacts, the number of modules that may be connected to the core processing unit 107 increases.

FIG. 9 illustrates the connector pair 700 in a state where the male connector 701 and the receptacle connector 704 are electrically disconnected, and FIG. 10 illustrates the connector pair 700 in a state where the male connector 701 and the receptacle connector 704 are electrically connected. The exposed terminals 702 are spring loaded to contact interface pad 707 of the receptacle connector 704, where the conductive gasket 703 contacts a ground connection associated with recessed rectangular slot 706. Since the exposed terminals are electrically connected to a module and the interface pads 707 are electrically connected to the core processing unit 107, data may be passed between the module and the core processing unit when the exposed terminals 702 contact the terminals 705. In an alternate implementation, at least some of the connectors merely provide a mechanical connection between the modules and the frame, or between the frame and the core processing unit, and the exchange of data occurs via a wireless connection.

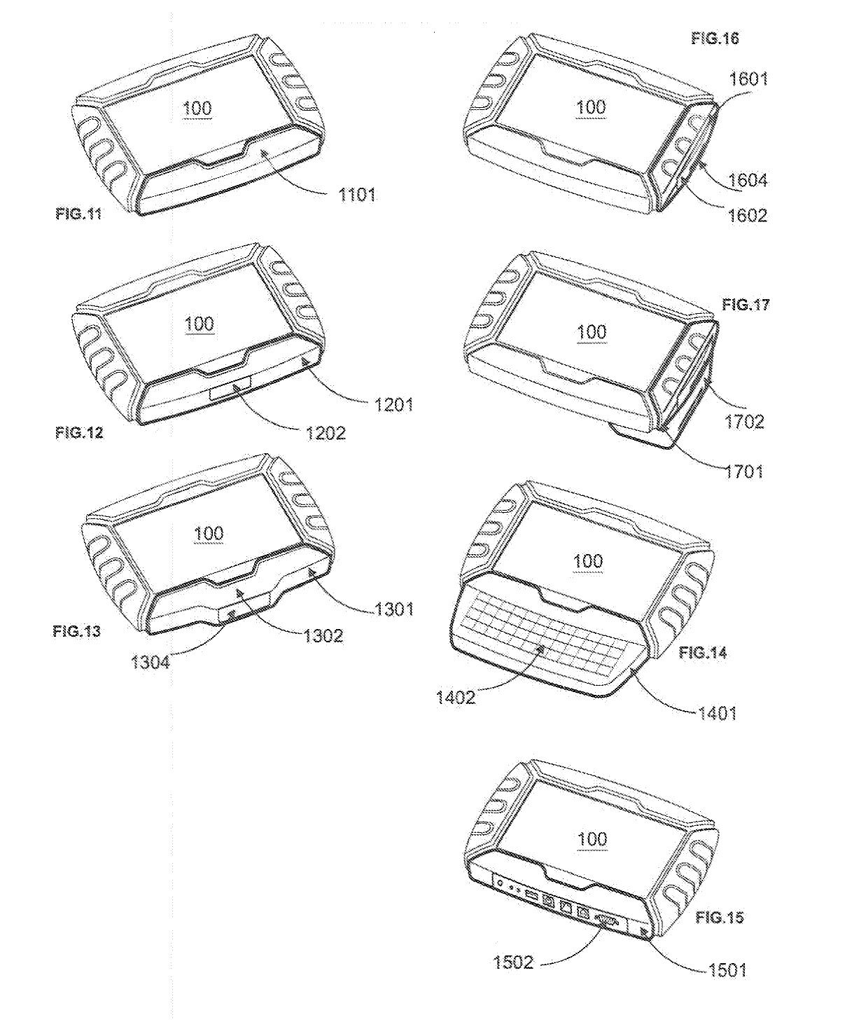

FIGS. 11 to 19 illustrate various exemplary modules connected to the frame 106. For example, FIG. 11 depicts a battery module 1101, FIG. 12 depicts an IR transmitter module 1201 including an IR scanner 1202, FIG. 13 depicts a bar code reader module 1301 including a bar code scanner 1302 projecting from an outer portion of the module 1301, along an exterior side of the module 1301 corresponding to the outer surface 146. The bar code reader module 1301 includes a reader window 1304, though which light is emitted from the bar code scanner 1302, to read an external bar code.

FIG. 14 depicts a keyboard module 1401 including keys 1402 for entering text data and user commands into the core processing unit 107. The keyboard module 1401 may include a full size QWERTY keyboard, or another size keyboard that is proportional to the size of the module 1401. For example, the keyboard may be scaled to a size that allows the user to press keys with only his thumbs rather than with all of his fingers. The keyboard may be sealed and/or illuminated. The module may include one or more hinges that enable the module, such as the keyboard, to be folded over the display 108 of the core processing unit 107.

FIG. 15 depicts a port replicator (or docking station) module 1501 including ports 1502 for enabling direct wireline connection of external peripheral devices via an audio port, a direct current (“DC”) power supply port, a universal serial bus (“USB”) port, a 9-pin (DB9) RS-232 port, or other ports. Using its constituent ports, the port replicator module 1501 may also be described as an adaptor, which allows dissimilar modules to be connected to a modular computing device. For instance, if the module is curved and the frame has substantially linear sides, the curved module may be connected to the frame by way of a connection through a port replicator. In this regard, in one example implementation, the port replicator merely has one port, and is intended to adapt frames and modular computing devices with non-matching modules. Because of their size and shape, each of modules 1101, 1201, 1301, 1401 and 1501 are configured to be connected to the third or fourth sides of the modular computing device kit 100, where modules 103 and 104 are connected in FIG. 1.

Thus, according to another general implementation, docking station includes a body housing electronics, the body defining a groove for receipt of a side of a core computing device and having a coupling positioned on the body within the groove for electrically contacting the core computing device, the body including pins extending from first and second ends of the body for mechanically interfacing with tabs extending from corners of a periphery of the core computing device, and the electronics enabling a wireline connection of peripheral devices.

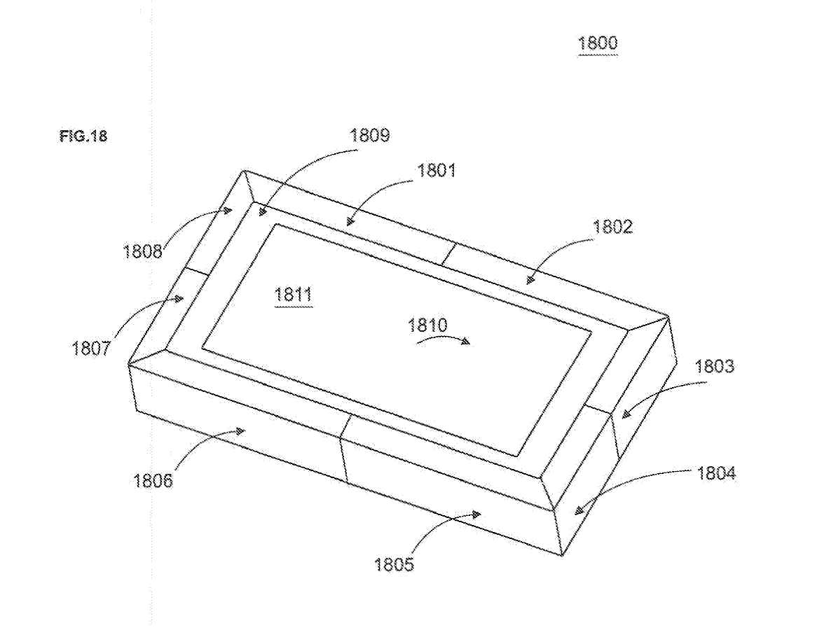

Additionally, FIG. 16 depicts a combined smart card reader module 1601 and magnetic stripe reader module, and FIG. 17 depicts an RFID reader module 1701. The modules, such as module 1601, may include one or more communication interfaces, such as an IrDA® interface, an IEEE® Standard 802.11 interface, a BLUETOOTH® interface, a NFC interface, an OFDM UWB interface, a TM-UWB interface, or other interface. The smart card reader module 1601 includes a smart card reader 1602 projecting from a side of the module 1601 corresponding to the outer surface 146, where the smart card reader includes a reader mechanism 1604 configured to read smart cards. The RFID reader module 1701 includes a RFID reader antenna projecting from a side of the module 1701 corresponding to the rear surface 147 configured to activate and read data from RFID tags.

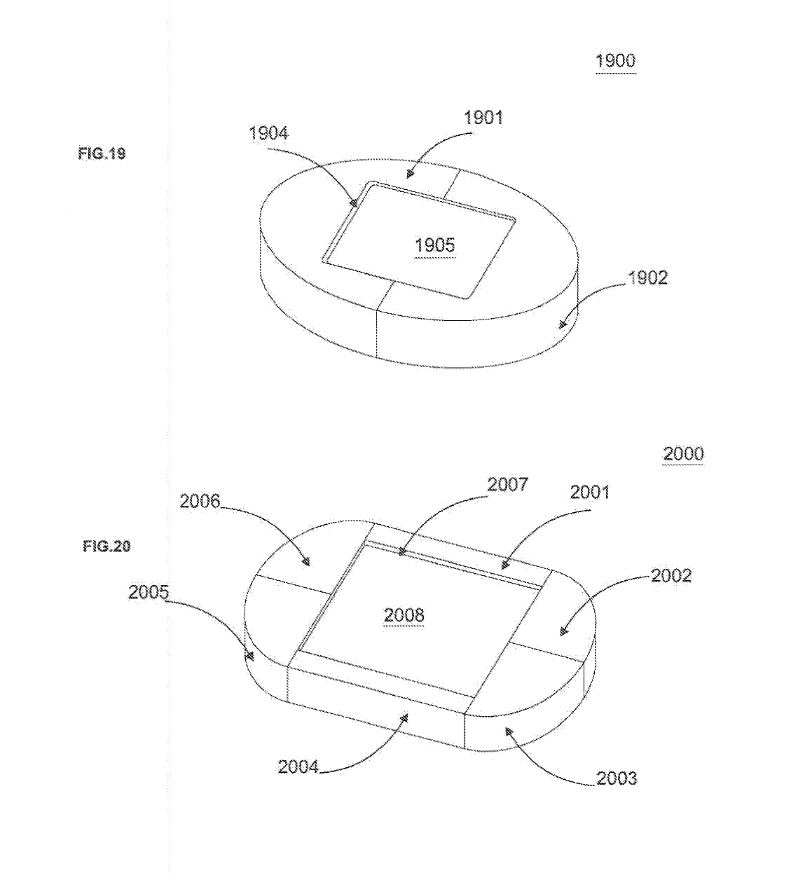

FIG. 18 is a perspective view of an exemplary four-sided modular computing device which is capable of coupling with up to eight modules, according to another general implementation. In particular, modular computing device 1800 includes modules 1801 to 1818 attached to a frame 1809 of the modular computing device 1800. The modules 1801 to 1808 are electrically connected to a core processing unit 1810 by way of non-depicted module-side and frame-side connectors. The core processing unit 1810 includes a display 1811.

Other mobile devices include fewer or more sides, enabling the connection of fewer or more modules to the associated core processing unit. For example, FIG. 19 is a perspective view of an exemplary modular computing device 1900 including two modules 1901 and 1902 each associated with each half of the modular computing device 1900 and attached to a frame 1904 of the modular computing device 1900. The modules 1901 and 1902 are electrically connected to a core processing unit 1905. FIG. 20 is a perspective view of an exemplary modular computing device 2000 including six modules 2001 to 2006 attached to a frame 2007 of the modular computing device 2000, and electrically connected to a core processing unit 2008.

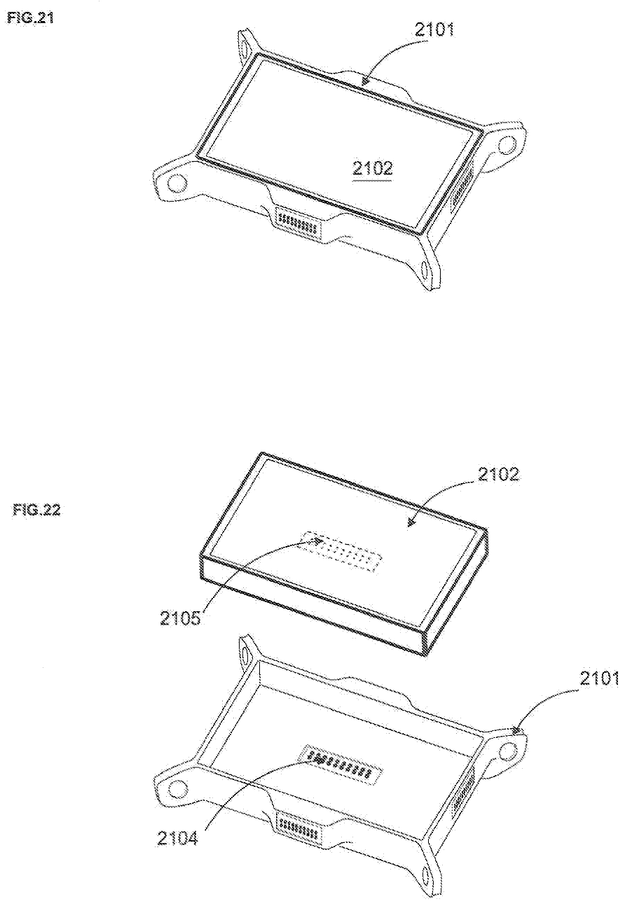

The frame can be a separate and discrete component that connects the core processing unit to the modules. In this regard, FIGS. 21 and 22 are perspective views of an exemplary frame and detachable core processing unit, in an attached and detached state, respectively. In particular, a frame 2101, which includes at least the features of the frame 106, also includes a cavity into which a core processing unit 2102 sits, in the attached state. A frame-side connector 2104 is disposed on the frame 2101, to electrically connect with a core processing unit-side connector 2105 on the underside of the core processing unit 2102. The core processing unit 2102 may be detached and removed from the frame 2101, as desired.

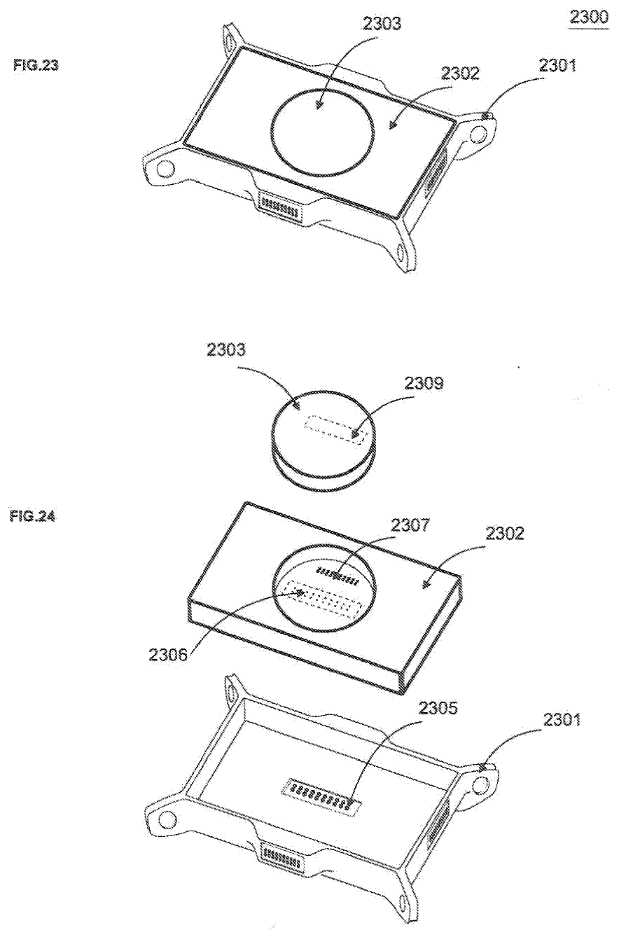

FIGS. 23 and 24 are perspective views of an exemplary frame, detachable core processing unit, and adapter, in an attached and detached state, respectively. In particular, a frame 2301, which includes at least the features of the frame 106, also includes a cavity into which an adapter 2302 and a core processing unit 2303 sit, in the attached state. A frame-side connector 2305 is disposed on the frame 2301, to electrically connect with an adapter-side connector 2306 on the underside of the adapter 2302, and an adapter-side connector 2307 is disposed on the adapter 2302 to electrically connect with a core processing unit-side connector 2309 disposed on the underside of the core processing unit 2302. The core processing unit 2302 may be detached and removed from the adapter 2302, and the adapter 2302 may be detached and removed from the frame 2301, as desired.

The adapter 2302 enables the core processing unit 2303 to be connected to one or more modules when the core processing unit 2303 and the modules may not be connected directly. For instance, if the core processing unit 2303 is circular and the extension modules are linear, the modules may not be able to directly connect to the core processing unit 2303 because the modules would not conform to the perimeter of the core processing unit 2303. By using an adapter 2303 to a rectangular frame 2301, however, such a connection is made possible. In addition, the adapter 2302 also may provide support and protection to, and define the shape of the modular computing device 2300. The core processing unit 2303 fits into a cavity within adapter 2302, which is sized and a shaped to enables multiple different core processing units to connect to the frame 2301. The cavity may include other features to mechanically hold the core processing unit 2303 in place.

Thus, according to another general implementation, the frame 2301 is for interfacing a core computer device, such as the core processing unit 2302, and a plurality of modules 101 to 104. The frame includes a body defining a cavity for receiving the core computing device, the body including a coupling positioned on the body within the cavity for electrically contacting the core computing device, the body defining a plurality of couplings for receiving a plurality of modules along a plurality of sides thereof, the body defining tabs extending from corners of a periphery of the body for mechanically interfacing with the modules. An adapter may be used for interfacing the core computing device and a plurality of modules, the adapter including a body configured for receiving the core computing device and the plurality of modules.

FIG. 25 is a perspective view of an exemplary modular computing device, in a state where four modules and a detachable core processing unit are detached from a frame of the modular computing device. In particular, a substantially rectangular modular computing device kit 2500 includes modules 2501 and 2502 which are respectively disposed on first and second opposite sides of a frame 2506 of a modular computing device kit 2500, and modules 2503 and 2504 which are respectively disposed on third and fourth opposite sides of the frame 2506 of the modular computing device. The modules 2501 and 2504 are mechanically connected, but are not necessarily electrically connected to the frame 2506 and a core processing unit 2507.

Unlike the frame 106 used by the modular computing device kit 100, the frame 2506 does not include connectors that are configured to electrically connect to module-side or core processing unit-side connectors, but instead interfaces with the core processing unit 2507 by way of a wireless connection, such as by using an NFC or BLUETOOTH® connection. Otherwise, the modular computing device kit 2500 is substantially similar in function and structure to the modular device kit 100. In an alternate implementation, the frame 2506 includes frame-side connectors, however one or more of the modules 2501 to 2504 do not electrically connect to the frame 2506 and core processing unit 2507 by way of the connectors, but instead interface wirelessly.

A number of implementations have been described. Nevertheless, it will be understood that various modifications may be made. Accordingly, other implementations are within the scope of the following claims.

What is claimed is:

1. A modular computing device kit, comprising:
a core having a body housing a processor, the body defining a plurality of couplings for receiving a plurality of modules along a plurality of sides thereof, and
at least one module configured for removable receipt by the coupling, the module, when received by the core, conforming to a perimeter of the core to define a form factor of the modular computing device.

2. The modular computing device kit of claim 1 further comprising a plurality of interchangeable modules.

3. The modular computing device kit of claim 1, wherein the body further houses a memory, an input interface, and a display.

4. The module computing device kit of claim 3, wherein the display has a width:height ratio of 16:9.

5. The modular computing device kit of claim 1, wherein the at least one module includes a global system for mobile communication (GSM) module, a general packet radio service (GPRS) module, an enhanced data GSM environment (EDGE) module, a wireless network interface module, a BLUETOOTH® module, a near field communications (NFC) module, an infrared (IR) transmitter, and IR receiver, a speaker, a keyboard, a user input module, a port replicator, a battery, a bar code reader, a radio frequency identification (RFID) tag reader, a smart card reader, a compact flash card reader, a magnetic stripe reader, a fingerprint reader, a global positioning satellite (GPS) receiver, a printer, an imager or scanner, a camera, a security access module (SAM), or a subscriber interface module (SIM).

6. The modular computing device kit of claim 1, wherein the coupling is a universal serial bus (USB) connection coupling, an inter-integrated circuit (I²C) connection coupling, a serial connection coupling, a parallel connection coupling, a Personal Computer Memory Card International Association (PCMCIA) card slot coupling, a Peripheral Component Interconnect (PCI) connection coupling, a small computer system interface (SCSI) connection coupling, or a PS/2 connection.

7. The modular computing device kit of claim 1, wherein, when the at least one module is received by the core, the form factor of the modular computer device is rectangular, square-shaped, round-shaped, polygonal, or has a combination of one or more straight sides and one or more curved sides.

8. The modular computing device kit of claim 1, wherein, when the at least one module is received by the core, a watertight or airtight seal is created between the at least one module and the core.

9. The modular computing device kit of claim 1, wherein the body includes at least four sides.

10. A core computing device, comprising:
a body housing a processor, the body defining a plurality of couplings for receiving a plurality of modules along a plurality of sides thereof, the body defining tabs extending from corners of a periphery of the body for mechanically interfacing with the modules.

11. A module, comprising:
a body housing electronics, the body defining a groove for receipt of a side of a core computing device and having a coupling positioned on the body within the groove for electrically contacting the core computing device, the body including pins extending from first and second ends of the body for mechanically interfacing with tabs extending from corners of a periphery of the core computing device.

12. The module of claim 11, wherein the pins are spring-loaded pins.

13. A frame for interfacing a core computing device and a plurality of modules, comprising:
a body defining a cavity for receiving the core computing device, the body including a coupling positioned on the body within the cavity for electrically contacting the core computing device, the body defining a plurality of couplings for receiving a plurality of modules along a plurality of sides thereof, the body defining tabs extending from corners of a periphery of the body for mechanically interfacing with the modules.

14. An adapter for interfacing a core computing device and a plurality of modules, comprising:
a body configured for receiving the core computing device of claim 10 and a plurality of the modules of claim 11.

15. A method of reconfiguring a computing device, comprising:
exchanging modules attached to a core of the computing device to change the functionality of the computing device, the modules, when attached to the core, conforming to a perimeter of the core to define a form factor of the computing device.

16. A docking station comprising:
a body housing electronics, the body defining a groove for receipt of a slide of a core computing device and having a coupling positioned on the body within the groove for electrically contacting the core computing device, the body including pins extending from first and second ends of the body for mechanically interfacing with tabs extending from corners of a periphery of the core computing device, and the electronics enabling a wireline connection of peripheral devices.
